(19) United States
(12) Patent Application Publication
(10) Pub. No.: US 2015/0143232 A1
(43) Pub. Date: May 21, 2015

(54) Tailoring Specification Information to User Needs

(71) Applicant: Government of the United States, as represented by the Secretary of the Air Force, Wright-Patterson AFB, OH (US)

(72) Inventor: Eric B. Treadwell, Kettering, OH (US)

(21) Appl. No.: 14/548,245

(22) Filed: Nov. 19, 2014

Related U.S. Application Data
(60) Provisional application No. 61/906,106, filed on Nov. 19, 2013.

(51) Int. Cl. G06F 17/24

(52) U.S. Cl. CPC G06F 17/24
USPC 715/254

(57) ABSTRACT

A new system for, first, creating a cross-reference between user characteristics and applicable portions of platform requirement documents; and, second, displaying on a case by case basis, only portions of platform requirement documents applicable to those user characteristics, starts with a Subject Matter Expert (SME) creating, from the platform requirement documents, a list of platform: (a) core requirements; (b) conditional physical requirements; and, (c) conditional procedural requirements; then cross-referencing those core requirements, conditional physical requirements and conditional procedural requirements with applicable portions of the platform requirement document; next creating a cross-reference between user characteristics that interact with the platform and their corresponding platform conditional physical requirements and conditional procedural requirements; and, finally, creating a list of those cross-referenced user characteristics. Then, on a case by case basis, a user indicates or specifies which user characteristics apply on the list of cross-referenced user characteristics. Finally, the system outputs a display or listing of only applicable portions of core requirements, conditional physical requirements and conditional procedural requirements from the platform requirement document.

### CROSS-REFERENCE TO RELATED APPLICATIONS

This application claims the benefit of the filing date of provisional application Ser. No. 61/906,106, filed Nov. 19, 2013, titled “Method for Accessing Specification Information,” and incorporates its contents by reference into this application.

### RIGHTS OF THE GOVERNMENT

The invention described herein may be manufactured and used by or for the Government of the United States for all governmental purposes without the payment of any royalty.

### BACKGROUND OF THE INVENTION

The present invention relates generally to methods for providing requirement and specification information to users, and more specifically to tailoring requirement or specification documents to provide users only those portions of those documents needed for a user's specific case or project.

Specifications are typically platform-centric or platform centered. That is, they are based on platform requirements and not on user requirements or needs.

Users typically have to wade through the entire text of a platform specification to find what they need to know to use the platform. Much time and efficiency can be gained if specifications and standards can be made more user-centric, or user centered, to provide users only with what they need to know to use the platform for which the specification is written.

For example, and the original problem which prompted finding the solutions provided by the present invention, specification and standards documents for cargo aircraft, MIL-HDBK-1791, “Designing for Internal Aerial Delivery in Fixed Wing Aircraft,” was originally written based on platform requirements, the dimensions, weights and other limitations, requirements and abilities of the cargo aircraft.

MIL-STD-1791A, a revision to MIL-HDBK-1791, communicates design requirements for aircraft physical and operational limits to designers and purchasers of new or modified equipment intended for transport via U.S. Air Force cargo aircraft. The standard must cover every conceivable type of cargo from any U.S. government user: trucks, tanks, planes, helicopters, boats, satellites, and humanitarian cargo such as Keiko, the killer whale. In addition, the standard contains guidance and lessons learned.

Users come to a problem, in this example, loading their equipment onto a cargo plane, knowing well only their equipment and its operation. They may know something about the cargo plane, the platform for this example, but rarely important details, particularly detailed requirements that may specifically apply to their equipment and even limit the ability for the cargo plane to carry the user's equipment.

Military Standards and similar documents are all about the platform, requiring a user to study far more than they want and need to determine whether their equipment can be carried on, or otherwise work with, that platform. What users need is some way to indicate, specify or enter as few characteristic details of their equipment as possible and have the standard return only what platform requirements they need to know. That is, the standard should, in a sense, act like, or substitute for, a human Subject Matter Expert (SME).

Subject Matter Experts (SMEs) can often ask only a few questions of a user, determine which specification requirements are applicable and even provide general guidance. The problem is that SMEs are few and often are available, if at all, only when a user actually encounters the platform, often too late to be truly useful. Cargo aircraft loadmasters, for example, may be first met only at the time of loading when it may be too late.

There is, therefore, a need for being able to display specification and standards information in a more user-centric fashion, including reducing the number of user equipment characteristics a user needs to identify.

### SUMMARY OF THE INVENTION

The teachings of the present invention solves the need for a more user centered providing of specification and standards requirements by a two-step system that: first, preferably once, tailors a requirements document to provide an improved interface for users to enter applicable user hardware or process characteristics; and, second, on a case by case basis, delivers to a user only those portions of the requirements document applicable to their needs.

An example embodiment of the teachings of the present invention dynamically tailors a requirements document by identifying user physical or process characteristics that interact with platform requirements, cross-referencing those user characteristics to those platform requirements and then cross-referencing those platform requirements to corresponding portions or provisions of the requirements document.

Another example embodiment of the teachings of the present invention creates lists of core and conditional platform requirements and then cross-references those platform requirements with their corresponding portions of the requirements document.

Yet another example embodiment of the teachings of the present invention creates lists of both physical and procedural conditional requirements.

Cross-referencing platform requirements to corresponding portions of a requirements document need only be performed as part of tailoring. Once tailoring is completed, case by case entering of user characteristics can be cross-referenced directly to applicable portions of a specification document.

### BRIEF DESCRIPTION OF THE DRAWINGS

The teachings of the present invention will be better understood from the accompanying drawings illustrating various aspects and example embodiments of the invention and its teachings.

FIG. 1 is a display, for an example embodiment of the teachings of the present invention applied to loading equipment onto a cargo aircraft, of user characteristics determined as interacting with platform requirements from which a user indicates which user characteristics apply to a given task.

FIG. 2 shows, for the example embodiment of applying the teachings of the present invention to loading equipment onto a cargo aircraft, example corresponding interacting user characteristics and platform requirements.

### DETAILED DESCRIPTION

While this description is primarily directed to an example embodiment of applying to the teachings of the present invention to loading equipment onto a cargo aircraft, it applies as well to any interaction of equipment or processes to either physical or process platforms.

Corralling wide-ranging information and fitting it to nearly unlimited items which can be transported is a challenge.

The teachings of the present invention tailors the content of a standardization document for the user of that document. The end result is an interactive process where the user describes, more precisely, chooses from a list, to a standards document a project at hand and the document replies with only applicable paragraphs. The focus is on the user's interaction with the document.

Tailoring does not change the content of a specification document. It does not necessarily change the organization of the document. Tailoring simply makes the information more accessible to a user. Users do not care about every single line; they only want to know what applies to their particular case. To help the user, a standards document author, or other SME, must think through how users interact with their document. How does the user go about the search for information? The SME first performs the search . . . backwards, in a sense, to prepare the document for tailoring.

The first task for an SME is to perform a requirements analysis as shown in Table 1. The first step in this analysis is to identify “core” requirements (those that always apply due to physics or laws). The second step is to identify “conditional” requirements. Next is to identify conditions wherein “conditional” requirements apply. Lastly, separate and identify “procedural” requirements (as opposed to physical requirements). Why separate procedural limits? Frequently, procedural limits are based on risk acceptance or best practice, things like speed limits. With a good enough reason you can do things differently or perhaps change or waive the restriction. Physical limits, like stall speed or structural strength, are immutable. Understanding the difference will help when the user comes for requirements relief.

TABLE 1
Requirements Analysis

1. Core Requirements
2. Conditional Requirements
3. Applicable Conditions
4. Procedural Requirements
5. Applicable Procedures

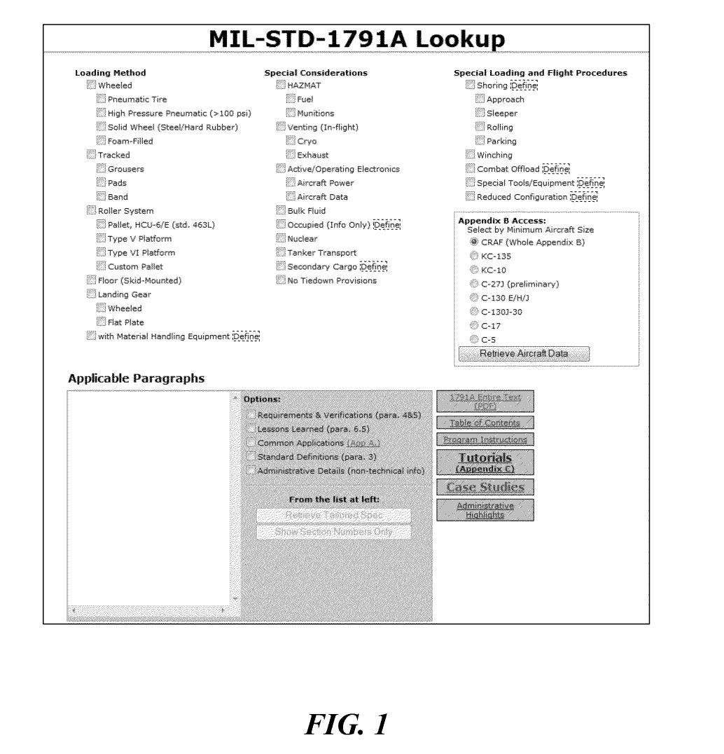

A user does not care what types of requirements are written. The user only cares about compliance. The conditions which will form the basis of the sorting routine are key to the user's successful interaction with the spec. In the example embodiment of applying the teachings of the present invention to loading equipment onto cargo aircraft, the owning organization for the original MIL-HDBK-1791 categorized at least 95 different types of cargo before abandoning the system. There is also a slowly changing roster of aircraft, with varying requirements, that one might try to organize the standard around. Rather than focus on either of these shifting categories, an interface approach was applied to arrive at twenty-nine cargo characteristics and eight procedures. There may be an unlimited number of possibilities for cargo, but there are comparatively few ways that cargo can interface, or interact, with an aircraft, as shown, for example, in FIG. 1. Keep in mind that while these examples are physical items of cargo, the item or items governed by a specification document may be physical items or a process and the teachings of the present invention will still be applicable.

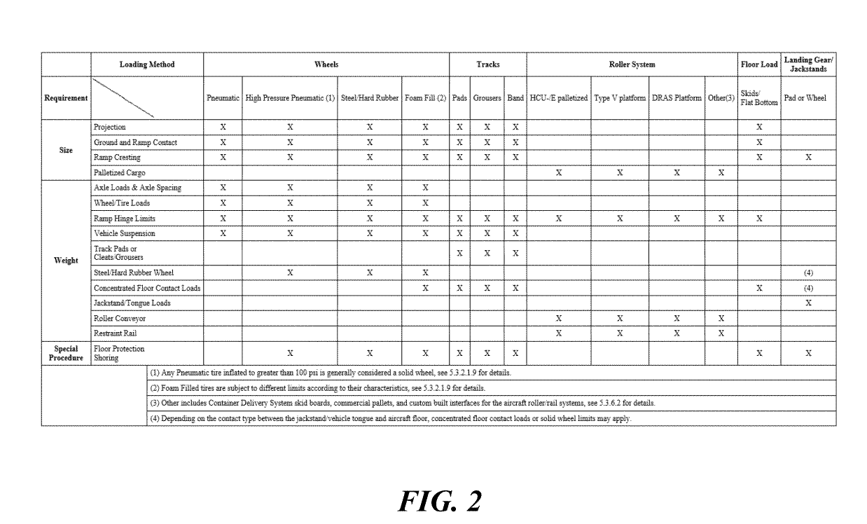

FIG. 2 shows some example corresponding interacting user characteristics and platform requirements.

Once the requirements have been analyzed, task two as shown in Table 2 correlates them. Conditions are correlated with conditional requirements, and procedures are correlated with procedural requirements. Three lists are then generated: the list of conditions and procedures, a correlation list for conditions/procedures and requirements, and the list of core requirements. Finally, those three lists are combined to produce a final list for display. Tailoring is complete and the specifically applicable and appropriate specification document is prepared for the user.

TABLE 2
Requirement Correlation

1. List Core Requirements
2. List Conditional and Procedural Requirements
3. List Conditions and Procedures
4. Correlate List #2 and List #3
5. Combine the core list and the results of Step 4.

To use a tailored specification or requirements document: first, a user identifies which conditions or characteristics their project matches; second, the user identifies which covered procedures are being used; lastly, the user consults the finally display list to identify applicable core requirements and applicable conditional and procedural requirements. Specification compliance verification may then proceed with a known, agreed-on subset of applicable requirements. The lists may be considered agreed-on (contractually, regulatory, etc.) because in the document the SME publishes the lists as a required part of the specification.

This process is simple to automate using current computer technology. In a manual, or user guide, implementation, the user is presented with the three lists (which may be formatted as tables or otherwise). In an electronic implementation, the user interface is based on a list of conditions and procedures and the computer program returns the core requirements along with any results that correlate to the selected conditions or procedures. In FIG. 1, the “Loading Method” and “Special Consideration” columns represent conditions, and the “Special Loading and Flight Procedures” column represents procedures, identified for MIL-STD-1791A.

The process may also be extended to include multiple, related documents. To stay with the transportation theme: MIL-STD-1366 (Transportability Criteria) references MIL-STD-1791A, along with MIL-STD-209, MIL-STD-129, MIL-STD-810, and MIL-STD-461, all of which may be required for an item being transported by Department of Defense assets. In order to link all the documents together for Dynamic Tailoring, all that is required is a wider Requirements Analysis.

Additional details of the teachings of the present invention are in Treadwell, E., “Search . . . Backwards,” Journal of Cyber Security and Information Systems, Vol. II, No. 1, April, 2014, which paper is included, in part, in the cross-referenced provisional patent application, and is fully incorporated by reference into this description.

Terms such as “platform,” “characteristics,” “documents,” etc. are used in this description, and in the accompanying claims, to make the descriptions more easily understood by referencing descriptive names more easily associated with the primary example embodiment of a standards document for cargo aircraft. Those with skill in the art of the invention will easily understand that those terms are not restricted to their limited meanings related to that example embodiment, but represent any conceptually similar item. For example, a platform may just as easily be a computer software system, user characteristics may be characteristics or features of other software systems intended to interact with that first computer software system and documents includes paper, digital and other media. Documents also include any type of information document, including, but not limited to, standards, specifications and requirements.

Where phrases with more than one term, such as “hardware or process,” are used, they are only to emphasize the broad applicability of the teachings of the present invention, and do not indicate that those, or related, terms are to be given more restricted meanings when used alone. Similarly, a terms such as “standards document” and “specification document” do not mean that the term “document” without such identifiers exclude any other type of document.

Similarly, those with skill in the art will recognize that the term “physical,” used in this description and in the claims to distinguish from “procedural,” can, and is intended to, include any not only tangible items, but also electromagnetic and any other “thing” which can be modeled mathematically.

Various other modifications to the invention as described may be made, as might occur to one with skill in the art of the invention, within the scope of the claims. Therefore, not all contemplated example embodiments have been shown in complete detail. Other embodiments may be developed without departing from the spirit of the invention or from the scope of the claims.

I claim:

1. A method for tailoring platform requirement documents to user characteristics, comprising the steps of:
(a) creating a list of platform requirements;
(b) cross-referencing the platform requirements with corresponding portions of a platform requirement document;
(c) identifying user characteristics that interact with the platform;
(d) cross-referencing those user characteristics that interact with the platform with corresponding platform requirements; and,
(e) creating a list of the cross-referenced user characteristics.

2. The method for tailoring platform requirement documents to user characteristics according to claim 1, further comprising the steps of:
(a) specifying which user characteristics apply to the list of cross-referenced user characteristics;
(b) displaying a listing of portions of the platform requirement document cross-referenced from the specified user characteristics.

3. A method for tailoring platform requirement documents to user characteristics, comprising the steps of:
(a) creating a list of:
(i) platform core requirements;
(ii) platform conditional physical requirements; and,
(iii) platform conditional procedural requirements;
(b) cross-referencing the platform core requirements, platform conditional physical requirements and platform conditional procedural requirements with corresponding portions of the platform requirement document;
(c) identifying user characteristics that interact with the platform;
(d) cross-referencing those user characteristics that interact with the platform with corresponding platform conditional physical requirements and platform conditional procedural requirements; and,
(e) creating a list of the cross-referenced user characteristics.

4. The method for tailoring platform requirement documents to user characteristics according to claim 3, further comprising the steps of:
(a) specifying which user characteristics apply to the list of cross-referenced user characteristics;
(b) displaying a listing of cross-referenced portions of the platform core requirements, platform conditional physical requirements and platform procedural requirements cross-referenced from the specified user characteristics.
